(19) United States
(12) Patent Application Publication
(10) Pub. No.: US 2017/0052081 A1
(43) Pub. Date: Feb. 23, 2017

(54) PRESSURE SENSOR, ALTIMETER, ELECTRONIC APPARATUS, AND MOVING OBJECT

(71) Applicant: Seiko Epson Corporation, Tokyo (JP)

(72) Inventor: Hiroyuki SHIMADA, Chuo (JP)

(21) Appl. No.: 15/234,360

(22) Filed: Aug. 11, 2016

(30) Foreign Application Priority Data
Aug. 19, 2015 (JP) 2015-161674

(51) Int. Cl. G01L 9/00; G01C 5/06

(52) U.S. Cl. CPC G01L 9/0054; G01C 5/06

(57) ABSTRACT

A pressure sensor includes a pressure sensor device including a diaphragm that undergoes bending deformation under pressure and a sensor section disposed on the diaphragm and a pressure sensor device including a diaphragm that undergoes bending deformation under pressure and a sensor section disposed on the diaphragm, and one of the sensor sections has a positive temperature characteristic, and the other has a negative temperature characteristic.

### BACKGROUND

1. Technical Field

The present invention relates to a pressure sensor, an altimeter, an electronic apparatus, and a moving object.

2. Related Art

As a pressure sensor of related art, there is a known pressure sensor described in JP-A-2006-47193. The pressure sensor described in JP-A-2006-47193 includes a semiconductor substrate provided with a diaphragm, a base bonded to the semiconductor substrate, a pressure reference chamber formed between the semiconductor substrate and the base, and piezo-resistance devices disposed on the diaphragm, and the pressure sensor detects the pressure acting thereon on the basis of a change in resistance of each of the piezo-resistance devices that changes in accordance with the amount of bending deformation of the diaphragm.

In the thus configured pressure sensor, however, the temperature sensitivity (temperature characteristic) greatly varies sensor to sensor. Although a correction circuit that corrects the varying temperature sensitivity is typically provided, a pressure sensor having temperature sensitivity that is too high for the correction circuit to correct is manufactured in some cases, and such a pressure sensor causes, for example, a decrease in manufacturing yield of the pressure sensor.

### SUMMARY

An advantage of some aspects of the invention is to provide a pressure sensor having low temperature sensitivity and an altimeter, an electronic apparatus, and a moving object each including the pressure sensor and therefore showing high reliability.

The advantage is achieved by the following aspects of the invention.

A pressure sensor according to an aspect of the invention includes a first pressure sensor device including a first diaphragm that undergoes bending deformation under pressure and a first sensor section disposed on the first diaphragm, and a second pressure sensor device including a second diaphragm that undergoes bending deformation under pressure and a second sensor section disposed on the second diaphragm, and one of the first sensor section and the second sensor section has a positive temperature characteristic, and another of the first sensor section and the second sensor section has a negative temperature characteristic.

Since the temperature characteristic of the first sensor section and the temperature characteristic of the second sensor section are canceled out with respect to each other, a pressure sensor having low temperature sensitivity is provided.

It is preferable that the pressure sensor according to the aspect of the invention further includes a pressure reference chamber, and the first pressure sensor device and the second pressure sensor device preferably share the pressure reference chamber.

With this configuration, the configuration of the pressure sensor is simplified, and the size of the pressure sensor can be reduced.

In the pressure sensor according to the aspect of the invention, it is preferable that the first diaphragm and the second diaphragm are so arranged as to face each other with the pressure reference chamber sandwiched therebetween.

With this configuration, the pressure reference chamber can be readily shared.

In the pressure sensor according to the aspect of the invention, it is preferable that the first sensor section has a piezo-resistance device disposed on a side of the first diaphragm opposite a side where the pressure reference chamber is present, and that the second sensor section has a piezo-resistance device disposed on a side of the second diaphragm opposite a side where the pressure reference chamber is present.

With this configuration, the first sensor section and the second sensor section can be simply configured.

In the pressure sensor according to the aspect of the invention, it is preferable that the first pressure sensor device has a first substrate provided with the first diaphragm, that the second pressure sensor device has a second substrate provided with the second diaphragm, and that the first substrate and the second substrate are so bonded to each other as to form the pressure reference chamber.

With this configuration, the pressure reference chamber can be readily formed.

In the pressure sensor according to the aspect of the invention, it is preferable that the first sensor section and the second sensor section form a bridge circuit.

With this configuration, pressure can be sensed with higher accuracy.

In the pressure sensor according to the aspect of the invention, it is preferable that the first diaphragm and the second diaphragm are arranged along a normal to one of the diaphragms.

With this configuration, for example, arranging the first diaphragm and the second diaphragm along the vertical direction allows the first sensor section and the second sensor section to cancel out gravitational acceleration acting on the pressure sensor.

An altimeter according to another aspect of the invention includes the pressure sensor according to the aspect of the invention.

With this configuration, a reliable altimeter can be provided.

An electronic apparatus according to another aspect of the invention includes the pressure sensor according to the aspect of the invention.

With this configuration, a reliable electronic apparatus can be provided.

A moving object according to another aspect of the invention includes the pressure sensor according to the aspect of the invention.

With this configuration, a reliable moving object can be provided.

### BRIEF DESCRIPTION OF THE DRAWINGS

The invention will be described with reference to the accompanying drawings, wherein like numbers reference like elements.

FIG. 1 is a cross-sectional view of a pressure sensor according to a first embodiment of the invention.

FIG. 2 is a plan view showing sensor sections provided in first and second pressure sensor devices.

FIG. 3 shows graphs illustrating temperature characteristics.

FIG. 4 shows a bridge circuit including the sensor sections shown in FIG. 2.

FIG. 5 is a cross-sectional view of a pressure sensor according to a second embodiment of the invention.

FIG. 6 is a perspective view showing an example of an altimeter according to an embodiment of the invention.

FIG. 7 is a front view showing an example of an electronic apparatus according to an embodiment of the invention.

FIG. 8 is a perspective view showing an example of a moving object according to an embodiment of the invention.

### DESCRIPTION OF EXEMPLARY EMBODIMENTS

A pressure sensor, an altimeter, an electronic apparatus, and a moving object according to embodiments of the invention will be described below in detail with reference to the accompanying drawings.

### First Embodiment

A pressure sensor according to a first embodiment of the invention will be first described.

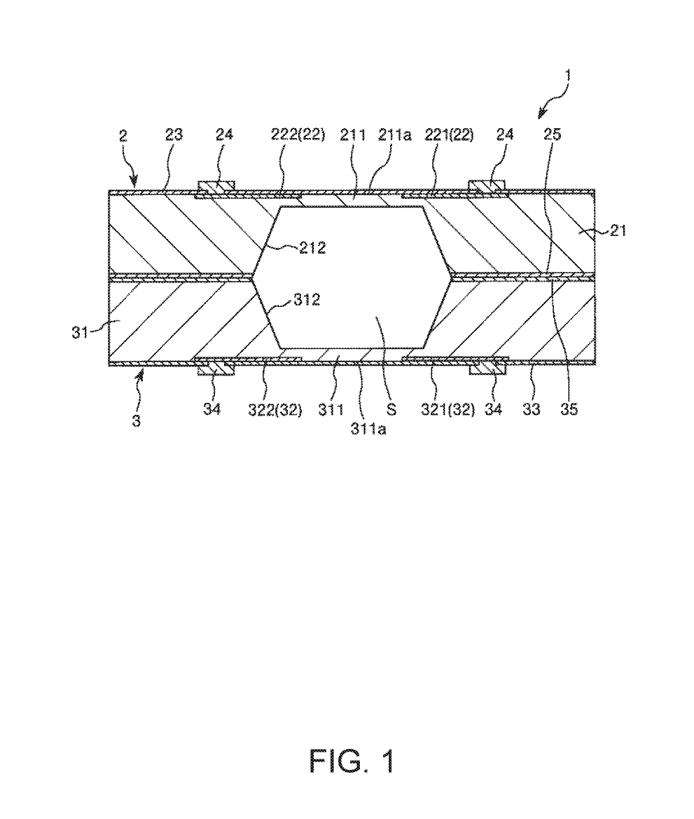

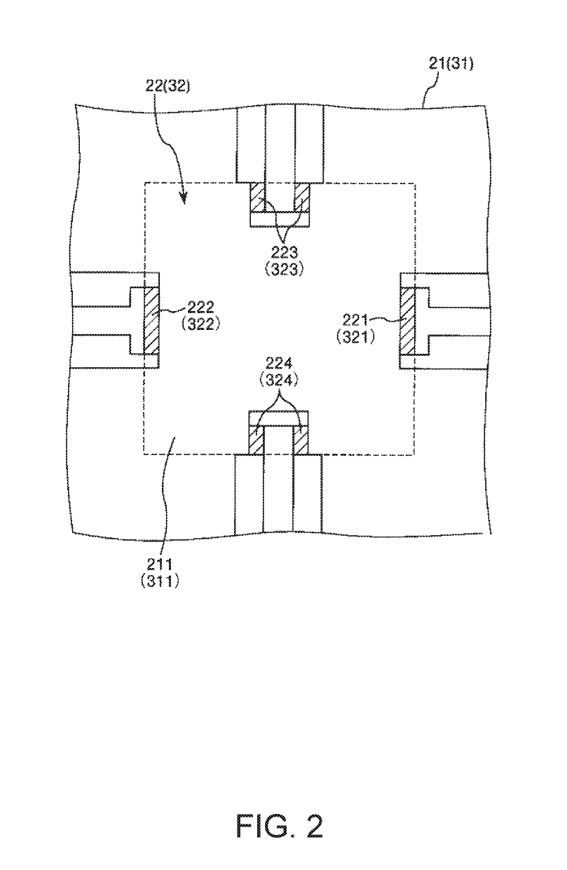

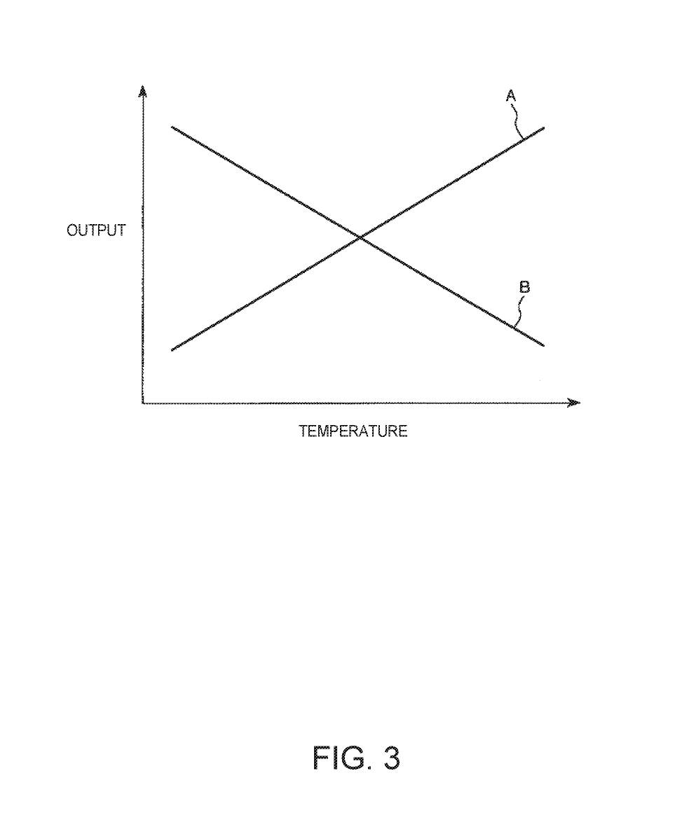

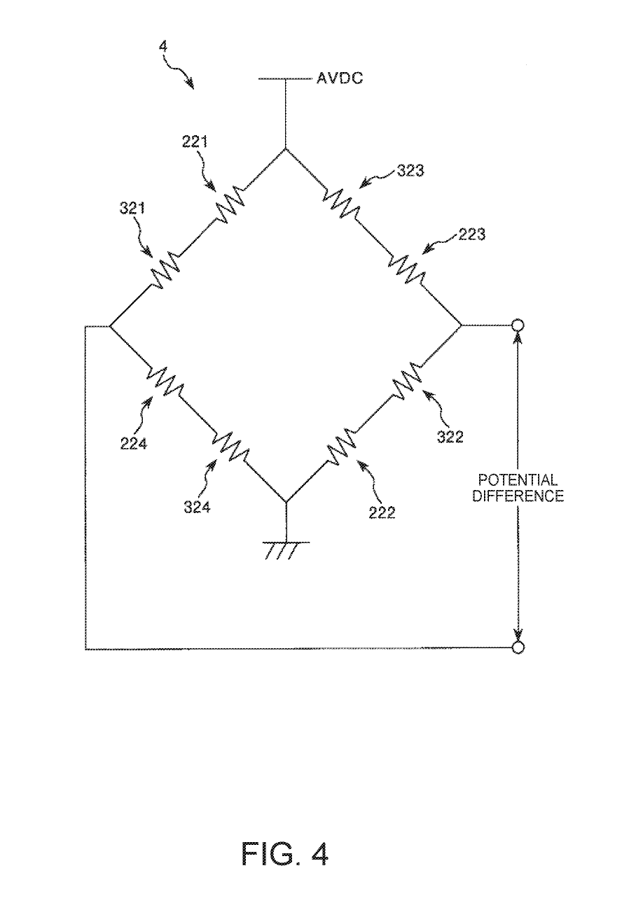

FIG. 1 is a cross-sectional view of the pressure sensor according to the first embodiment of the invention. FIG. 2 is a plan view showing sensor sections provided in first and second pressure sensor devices. FIG. 3 shows graphs illustrating temperature characteristics. FIG. 4 shows a bridge circuit including the sensor section shown in FIG. 2. In the following description, the upper side in FIG. 1 is also called “upper,” and the lower side in FIG. 1 is also called “lower.”

A pressure sensor 1 shown in FIG. 1 can sense pressure acting thereon. The pressure sensor 1 includes a first pressure sensor device 2 and a second pressure sensor device 3, which are so bonded to each other as to face away from each other, and a cavity S, which is provided between the first pressure sensor device 2 and the second pressure sensor device 3. Each of the sections described above will be sequentially described below.

### First Pressure Sensor Device

The first pressure sensor device 2 includes a substrate (first substrate) 21 and a sensor section (first sensor section) 22 provided on the substrate 21.

The substrate 21 has a diaphragm (first diaphragm) 211, which is thinner than the portion around the diaphragm 211 and undergoes bending deformation under pressure. The diaphragm 211 is formed by providing a bottomed recess 212, which is open through the lower surface of the substrate 21. The upper surface of the diaphragm 211 (surface facing away from recess 212) servers as a pressure receiving surface 211a. The thus configured substrate 21 can, for example, be a Si (silicon) substrate or any other semiconductor substrate.

The sensor section 22 has four piezo-resistance devices 221, 222, 223, and 224, which are provided on the diaphragm 211, and wiring lines connected to the four piezo-resistance devices, as shown in FIG. 2. The piezo-resistance devices 221 to 224 are provided on the upper surface of the substrate 21 (surface facing away from cavity S). Since the upper surface of the substrate 21 is a flat surface with substantially no step, the piezo-resistance devices 221, 222, 223, and 224 and the wiring lines are readily formed than in a case where the piezo-resistance devices and the wiring lines are formed on the lower surface of the substrate 21. Further, since the wiring lines are readily exposed to the space outside the pressure sensor 1, the wiring lines are readily connected to an external apparatus. It is, however, noted that the piezo-resistance devices 221, 222, 223, and 224 and the wiring lines may be provided on the lower surface of the substrate 21 (surface facing cavity S).

An insulating film 23, which is formed, for example, of a silicon oxide film (SiO₂ film), is formed on the upper surface of the substrate 21, and terminals 24, which are electrically connected to the wiring lines, are provided on the insulating film 23. The terminals 24 can therefore be readily connected to an external apparatus.

Each of the piezo-resistance devices 221 to 224 can be formed, for example, by doping (diffusing or implanting) an impurity, such as phosphorous and boron, into the substrate 21. The wiring lines connected to the piezo-resistance devices 221 to 224 can be formed, for example, by doping (diffusing or implanting) an impurity, such as phosphorous and boron, into the substrate 21 at higher concentration than the concentration of the impurity in the piezo-resistance devices 221 to 224.

### Second Pressure Sensor Device

The second pressure sensor device 3 has the same configuration as that of the first pressure sensor device 2 described above. The second pressure sensor device 3 will therefore be described in a simplified manner. The second pressure sensor device 3 includes a substrate (second substrate) 31 and a sensor section (second sensor section) 32 provided on the substrate 31.

The substrate 31 has a diaphragm (second diaphragm) 311, which undergoes bending deformation under pressure. The diaphragm 311 is formed by providing a bottomed recess 312, which is open through the upper surface of the substrate 31. The lower surface of the diaphragm 311 (surface facing away from recess 312) servers as a pressure receiving surface 311a.

The sensor section 32 has four piezo-resistance devices 321, 322, 323, and 324, which are provided on the diaphragm 311, and wiring lines connected to the four piezo-resistance devices, as shown in FIG. 2. The piezo-resistance devices 321 to 324 are provided on the lower surface of the substrate 31 (surface facing away from cavity S).

An insulating film 33 is formed on the lower surface of the substrate 31, and terminals 34, which are electrically connected to the wiring lines, are provided on the insulating film 33.

The configurations of the first pressure sensor device 2 and the second pressure sensor device 3 have been described above. The first and second pressure sensor devices 2, 3 are so arranged as to face away from each other and so bonded to each other that the recesses 212 and 312 define the cavity S, as shown in FIG. 1. In other words, the surface of the substrate 21 through which the recess 212 opens and the surface of the substrate 31 through which the recess 312 opens are bonded to each other, and the cavity S is formed of the recesses 212 and 312 that communicate with each other. The configuration described above allows the cavity S to be readily formed and further allows the size of the pressure sensor 1 to be reduced.

How to bond the substrates 21 and 31 to each other is not limited to a specific method. In the present embodiment, an SiO₂ film 25 is provided on the lower surface of the substrate 21, an SiO₂ film 35 is provided on the lower surface of the substrate 31, and the substrates 21 and 31 are bonded to each other in anodic bonding. The anodic bonding, which allows the substrates 21 and 31 to be bonded more securely than in normal bonding, increases the mechanical strength of the pressure sensor 1 and improves airtightness of the cavity S. When each of the substrates 21 and 31 is formed of an Si substrate, the SiO₂ films 25 and 35 can be readily formed by thermal oxidation, whereby the bonding can be readily performed.

### Cavity

The cavity S is formed between the substrates 21 and 31 bonded to each other, as described above. The thus formed cavity S is a sealed space and functions as a pressure reference chamber that provides a reference value of the pressure detected with the pressure sensor 1 (first pressure sensor device 2 and second pressure sensor device 3). The cavity S preferably is a vacuum (having pressure approximately lower than or equal to 10 Pa, for example). When the cavity S is brought into a vacuum, the pressure sensor 1 can be used as what is called an “absolute pressure sensor” that detects pressure with respect to the vacuum. A highly convenient pressure sensor 1 is therefore provided. It is, however, noted that the cavity S does not need to be a vacuum as long as the pressure in the cavity S is maintained constant.

The configuration described above in which the first pressure sensor device 2 and the second pressure sensor device 3 share the cavity S allows the first pressure sensor device 2 and the second pressure sensor device 3 to refer to the same reference pressure, whereby the pressure is sensed with improved accuracy. Further, the size of the pressure sensor 1 can be reduced.

In particular, the configuration in the present embodiment, in which the diaphragms 211 and 311 face each other with the cavity S sandwiched therebetween, readily allows the cavity S to be shared. The configuration further allows the size of the pressure sensor 1 to be more effectively reduced. Moreover, since the first pressure sensor device 2 and the second pressure sensor device 3 can be symmetrically arranged with respect to the cavity S, the amount of bending of the pressure sensor 1 due, for example, to thermal expansion can be reduced. As a result, the amount of undesired bending of the diaphragms 211 and 311 due to external force other than pressure acting thereon can be reduced, whereby the pressure is sensed with more improved accuracy.

The overall configuration of the pressure sensor 1 has been briefly described.

The sensor section 22 and the sensor section 32 provided in the pressure sensor 1 have temperature characteristics opposite to each other over an operating temperature band (from about −20.0° C. to +80.0° C., for example). That is, one of the sensor section 22 and the sensor section 32 has a positive temperature characteristic, and the other has a negative temperature characteristic. The following description will be made on the assumption that the sensor section 22 has a positive temperature characteristic and the sensor section 32 has a negative temperature characteristic for ease of description.

The “positive temperature characteristic” described above means that the sensor section 22 has a characteristic in which the pressure to be sensed does not change but the output from the sensor section 22 increases as the temperature rises, as indicated by the solid line A in FIG. 3, whereas the “negative temperature characteristic” described above means that the sensor section 32 has a characteristic in which the pressure to be sensed does not change but the output from the sensor section 32 decreases as the temperature rises, as indicated by the solid line B in FIG. 3.

As described above, since the pressure sensor 1 includes the sensor section 22, which has the positive temperature characteristic, and the sensor section 32, which has the negative temperature characteristic, the temperature characteristic of the sensor section 22 (output variation dependent on temperature) and the temperature characteristic of the sensor section 32 (output variation dependent on temperature) can be canceled out, whereby a pressure sensor 1 having low temperature sensitivity is provided. The pressure sensor 1 can therefore achieve excellent pressure sensing accuracy. Further, in the pressure sensor 1, the correction limitation of the correction circuit for temperature characteristic correction is unlikely to be reached, whereby the yield of the pressure sensor 1 is improved.

In actual manufacture of the pressure sensor 1, the following method may be employed. First, a large number of pressure sensor devices having the same structure as that of the first and second pressure sensor devices 2, 3 are manufactured. The large number of pressure sensor devices are then classified into pressure sensor devices having low temperature sensitivity (temperature characteristic within correction limitation of correction circuit) and pressure sensor devices having high temperature sensitivity (temperature characteristic beyond correction limitation of correction circuit). Each of the pressure sensor devices having low temperature sensitivity is individually used as a pressure sensor. On the other hand, among the pressure sensor devices having high temperature sensitivity, pressure sensor devices having opposite temperature characteristics are combined with each other, and the combined pressure sensor devices are used as the pressure sensor 1 according to the present embodiment. According to the method described above, each of the manufactured pressure sensor devices can be used in an application suitable for the pressure sensor device, whereby the pressure sensor devices can be effectively used with no waste of the manufactured pressure sensor devices.

Now, use a least squares method or any other method to express the temperature characteristic of each of the sensor sections in the form of a linear function (y=ax+b, where y represents output and x represents temperature), and let a1 be the gradient of the linear function that expresses the positive temperature characteristic of the sensor section 22, and a2 be the gradient of the linear function that expresses the negative temperature characteristic of the sensor section 32. It is preferable to satisfy a relationship of 0.7≦|a2/a1|≦1.3, more preferably, 0.9≦|a2/a1|≦1.1. As a result, the positive temperature characteristic of the sensor section 22 and the negative temperature characteristic of the sensor section 32 have a symmetric relationship and can therefore be more effectively canceled out.

Further, in the present embodiment, the piezo-resistance devices 221 to 224 in the sensor section 22 and the piezo-resistance devices 321 to 324 in the sensor section 32 are connected to each other as shown in FIG. 4 to form a bridge circuit (Wheatstone bridge circuit) 4.

A drive circuit (not shown) that supplies drive voltage AVDC is connected to the bridge circuit 4, and the bridge circuit 4 outputs a signal (voltage) according to changes in the resistance of the piezo-resistance devices 221, 222, 223, and 224 based on bending of the diaphragm 211 and changes in the resistance of the piezo-resistance devices 321, 322, 323, and 324 based on bending of the diaphragm 311. The thus configured bridge circuit 4 allows self-cancellation of the temperature characteristics of the sensor section 22 and the sensor section 32. As a result, excellent pressure sensing accuracy is achieved, and the circuit configuration is simplified.

When the thus configured pressure sensor 1 is used, the diaphragm 211 and the diaphragm 311 are preferably arranged along a normal to one of the diaphragms. The arrangement allows the pressure sensor 1 to be so configured that one of the diaphragms 211 and 311 is located on the upper side in the vertical direction and the other is located on the lower side in the vertical direction. The gravitational acceleration therefore causes concave deformation of the pressure receiving surface 211a of the diaphragm 211 and convex deformation of the pressure receiving surface 311a of the diaphragm 311. As a result, the gravitational acceleration acting on the sensor section 22 and the gravitational acceleration acting on the sensor section 32 can be self-canceled, whereby more excellent pressure sensing accuracy is achieved.

The posture of the pressure sensor 1 in use is not limited to the posture described above. For example, the diaphragm 211 and the diaphragm 311 may be arranged along the horizontal direction. The horizontal arrangement allows self-cancellation of acceleration in the horizontal direction.

### Second Embodiment

A pressure sensor according to a second embodiment of the invention will next be described.

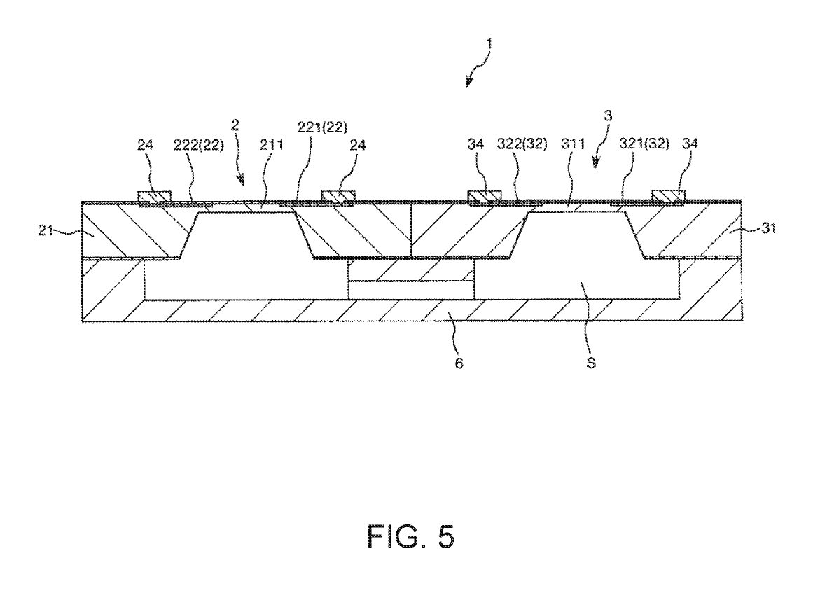

FIG. 5 is a cross-sectional view of the pressure sensor according to the second embodiment of the invention.

The pressure sensor according to the second embodiment will be described below. The description will be made primarily on differences from the embodiment described above, and the same items will not be described.

In the pressure sensor 1 shown in FIG. 5, the first pressure sensor device 2 and the second pressure sensor device 3 are arranged side by side along the transverse direction (in-plane direction of diaphragms 211 and 311). Further, the pressure sensor 1 includes a support substrate 6, which supports the first pressure sensor device 2 and the second pressure sensor device 3, and the support substrate 6 and the first and second pressure sensor devices 2, 3 define the cavity S.

The second embodiment described above can also provide the same advantageous effects provided by the first embodiment described above.

### Third Embodiment

An altimeter according to a third embodiment of the invention will next be described.

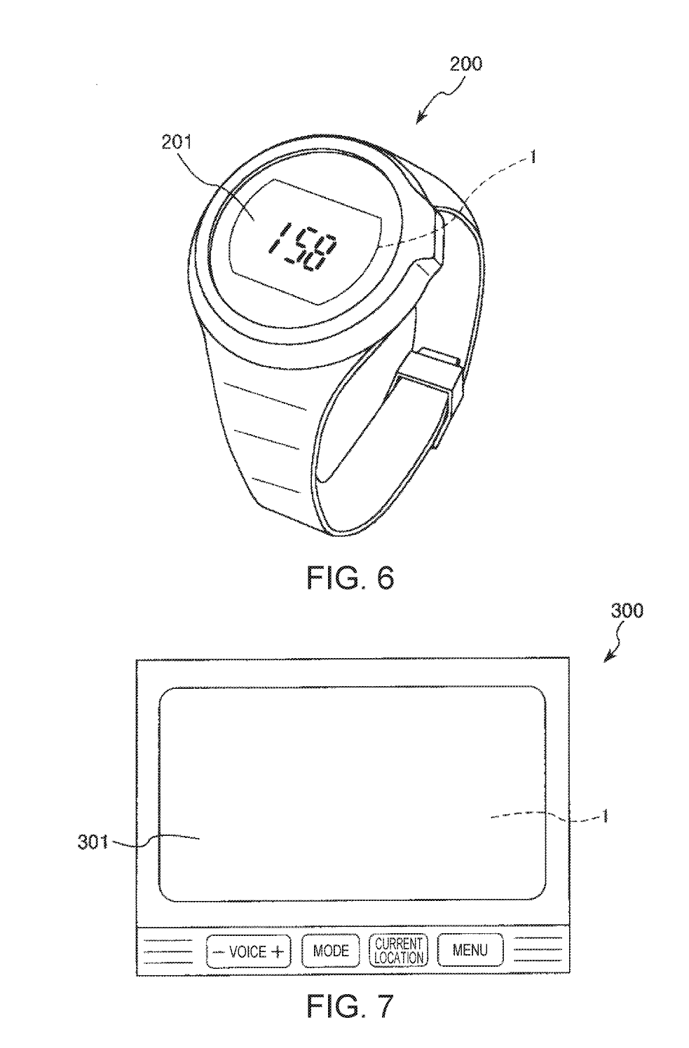

FIG. 6 is a perspective view showing an example of the altimeter according to the third embodiment of the invention.

An altimeter 200 can be worn around a wrist, as if it were a wristwatch, as shown in FIG. 6. The pressure sensor 1 is incorporated in the altimeter 200, and the altitude of the current location above sea level, the atmospheric pressure at the current location, or any other information can be displayed in a display section 201. The display section 201 can display a variety of pieces of information, such as the current time, a user's heart rate, and the weather. The thus configured altimeter 200, which includes the pressure sensor 1, can be highly reliable.

### Fourth Embodiment

An electronic apparatus according to a fourth embodiment of the invention will next be described.

FIG. 7 is a front view showing an example of the electronic apparatus according to the fourth embodiment of the invention.

The electronic apparatus according to the present embodiment is a navigation system 300 including the pressure sensor 1. The navigation system 300 includes map information that is not shown, a position information acquisition section that acquires position information from a GPS (global positioning system), a self-contained navigation section based on a gyro sensor and an acceleration sensor as well as vehicle speed data, the pressure sensor 1, and a display section 301, which displays predetermined position information or route information, as shown in FIG. 7.

According to the navigation system, altitude information can be acquired in addition to acquired position information. For example, in a case where a vehicle with no altitude information travels along an elevated road expressed in positional information by roughly the same position as the position representing a ground road, a navigation system of related art cannot determine whether the vehicle travels along the ground road or the elevated road and provides a user with information on the ground road as priority information.

Incorporating the pressure sensor 1 in the navigation system 300 and causing the pressure sensor 1 to acquire altitude information allows detection of a change in altitude that occurs when the vehicle travels out of the ground road onto the elevated road and the user to acquire navigation information on a running state along the elevated road.

An electronic apparatus including the pressure sensor according to any of the embodiments of the invention is not limited to the navigation system described above and can, for example, be a smartphone, a tablet terminal, a timepiece, a personal computer, a mobile phone, medical apparatus (such as electronic thermometer, blood pressure gauge, blood sugar meter, electrocardiograph, ultrasonic diagnostic apparatus, and electronic endoscope), a variety of measuring apparatus, a variety of instruments (such as instruments in vehicles, airplanes, and ships), and a flight simulator.

### Fifth Embodiment

A moving object according to a fifth embodiment of the invention will next be described.

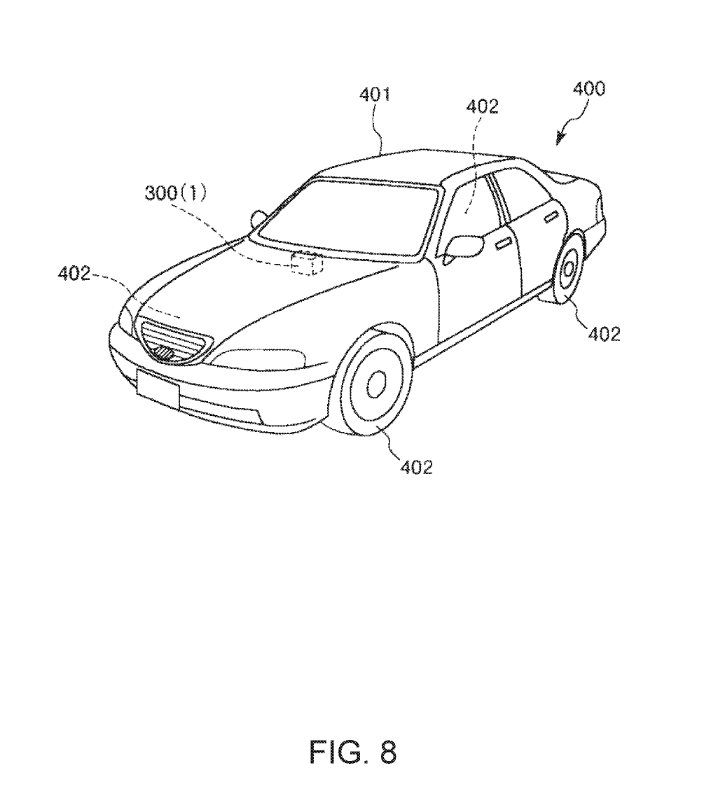

FIG. 8 is a perspective view showing an example of the moving object according to the fifth embodiment of the invention.

The moving object according to the present embodiment is an automobile 400 including the pressure sensor 1. As shown in FIG. 8, the automobile 400 includes a vehicle body 401 and four wheels 402, and a power source (engine) that is not shown but is provided in the vehicle body 401 rotates the wheels 402. The thus configured automobile 400 accommodates the navigation system 300 (pressure sensor 1).

The pressure sensor, the altimeter, the electronic apparatus, and the moving object according to the embodiments of the invention have been described above with reference to the drawings, but the invention is not limited thereto. The configuration of each portion in the embodiments can be replaced with an arbitrary configuration having the same function, and another arbitrary configuration and step may be added. Further, the embodiments may be combined with each other as appropriate.

In the embodiments described above, the description has been made with reference to the case where piezo-resistance devices are used as each of the sensor sections. The pressure sensor is, however, not necessarily configured as described above and can, for example, have a configuration in which a flap-type vibrator is used or can, for example, use a MEMS vibrator, such as an interdigital transducer, and a vibration device, such as a quartz vibrator.

The entire disclosure of Japanese Patent Application No. 2015-161674, filed Aug. 19, 2015 is expressly incorporated by reference herein.

What is claimed is:

1. A pressure sensor comprising:
a first pressure sensor device including a first diaphragm that undergoes bending deformation under pressure and a first sensor section disposed on the first diaphragm; and
a second pressure sensor device including a second diaphragm that undergoes bending deformation under pressure and a second sensor section disposed on the second diaphragm,
wherein one of the first sensor section and the second sensor section has a positive temperature characteristic, and another of the first sensor section and the second sensor section has a negative temperature characteristic.

2. The pressure sensor according to claim 1, further comprising a pressure reference chamber,
wherein the first pressure sensor device and the second pressure sensor device share the pressure reference chamber.

3. The pressure sensor according to claim 1, wherein the first diaphragm and the second diaphragm are so arranged as to face each other with the pressure reference chamber sandwiched therebetween.

4. The pressure sensor according to claim 3,
wherein the first sensor section has a piezo-resistance device disposed on a side of the first diaphragm opposite a side where the pressure reference chamber is present, and
the second sensor section has a piezo-resistance device disposed on a side of the second diaphragm opposite a side where the pressure reference chamber is present.

5. The pressure sensor according to claim 2,
wherein the first pressure sensor device has a first substrate provided with the first diaphragm,
the second pressure sensor device has a second substrate provided with the second diaphragm, and
the first substrate and the second substrate are so bonded to each other as to form the pressure reference chamber.

6. The pressure sensor according to claim 1, wherein the first sensor section and the second sensor section form a bridge circuit.

7. The pressure sensor according to claim 1, wherein the first diaphragm and the second diaphragm are arranged along a normal to one of the diaphragms.

8. An altimeter comprising the pressure sensor according to claim 1.

9. An altimeter comprising the pressure sensor according to claim 2.

10. An altimeter comprising the pressure sensor according to claim 3.

11. An altimeter comprising the pressure sensor according to claim 4.

12. An altimeter comprising the pressure sensor according to claim 5.

13. An electronic apparatus comprising the pressure sensor according to claim 1.

14. An electronic apparatus comprising the pressure sensor according to claim 2.

15. An electronic apparatus comprising the pressure sensor according to claim 3.

16. An electronic apparatus comprising the pressure sensor according to claim 4.

17. A moving object comprising the pressure sensor according to claim 1.

18. A moving object comprising the pressure sensor according to claim 2.

19. A moving object comprising the pressure sensor according to claim 3.

20. A moving object comprising the pressure sensor according to claim 4.
